(19) United States
(12) Patent Application Publication
(10) Pub. No.: US 2021/0396231 A1
(43) Pub. Date: Dec. 23, 2021

(54) ROTARY-VANE MECHANISM FOR ENGINES AND COMPRESSORS

(71) Applicant: Vladimir Shapovalov, Albuquerque, NM (US)

(72) Inventor: Vladimir Shapovalov, Albuquerque, NM (US)

(21) Appl. No.: 17/125,352

(22) Filed: Dec. 17, 2020

Related U.S. Application Data
(60) Provisional application No. 63/042,100, filed on Jun. 22, 2020.
(60) Provisional application No. 63/094,744, filed on Oct. 21, 2020.

(51) Int. Cl. F04C 27/00; F02B 53/12; F02B 53/04; F04C 18/344; F01C 21/08; F01C 21/10

(52) U.S. Cl. CPC F04C 27/001; F02B 53/12; F01C 21/106; F04C 18/3441; F01C 21/0809; F02B 53/04

(57) ABSTRACT

A rotary-vane mechanism can include a rotor and a casing, wherein the rotor includes a drive shaft and one or more vanes. The casing can include a quasi-cylindrical tubular shell or a quasi-spherical shell, and can provide walls that support the drive shaft. The rotor can be mounted within the casing. The drive shaft can extend outward from the casing, wherein the drive shaft touches the inner surface of the casing in one or more contact locations, with the contact location(s) provided by a sealing plate. The casing can include intake ports, exhaust ports, ports for an ignition mechanism, wherein the intake ports are provided with one-way valves. The drive shaft can include one or more guide slots, which can penetrate through the drive shaft wherein the vane(s) is located inside the guide slot(s), and edges of the vane(s) can constantly touch the inner surface of the casing during a rotor rotation of the rotor. Each vane can possess a rectangular shape or a discoid shape, and the sealing plate or a sealing ring can be located along an edge of the vane(s). The rotor and the casing can form isolated spaces inside the rotary-vane mechanism and during the rotor rotation can provide three work strokes for an engine, and two strokes for a compressor.

### CROSS-REFERENCE TO PROVISIONAL APPLICATIONS

This patent application claims priority under 35 U.S.C. 119(e) to U.S. Provisional Patent Application Ser. No. 63/042,100 entitled “Rotary-Vane Mechanism for Engines and Compressors,” which was filed on Jun. 22, 2020, the disclosure of which is incorporated herein by reference in its entirety. This patent application also claims priority under 35 U.S.C. 119(e) to U.S. Provisional Patent Application Ser. No. 63/094,744 entitled “Rotary-Vane Mechanism for Engines and Compressors,” which was filed on Oct. 21, 2020, the disclosure of which is incorporated herein by reference in its entirety.

### TECHNICAL FIELD

Embodiments are related to energy systems. Embodiments further relate to the design and thermodynamic cycle of vane rotary-type engines that are simple, durable, lightweight and foolproof and that can be operated with a variety of types of fuels.

### BACKGROUND

In conventional Otto piston engines, four-strokes—intake, compression, power and exhaust are carried out in the same cylinder. Much of the thermal energy that is generated is exhausted along with waste gases because gases that burn at high temperatures and pressures cannot expand sufficiently during the power stroke. Additional power may be lost as it is transmitted through the piston and the connecting rod at the top of the piston to the crankshaft. In addition, the driving of valves can consume engine power and can create additional noise and vibrations. Furthermore, there may be inertia losses as the valves and pistons reciprocate. These inertia losses can increase as the engine's speed increases and can severely affect the acceleration character and top velocity of the engine. Its large volume, heavy weight, complicated structure, and large numbers, along with the strict requirements for manufactured technology, high costs, and high fault failure rates, also disadvantage the Otto piston engine.

Rotary internal combustion engines, which can incorporate a rotary-vane mechanism (further RVM), can offer many advantages over the common piston-type reciprocating engine. Among these advantages are a higher power-to-weight ratio, fewer moving parts and better dynamic balancing for smoother and quieter operation. With its small volume, lightweight, little inertia loss, reduced vibration and fewer moving parts, the rotary engine has been proposed as an alternative or complementary to the conventional piston engine. The Wankel Rotary Engine built by the German engineer Felix Wankel in the 1950s is one successful example, and the turbine jet engine is another.

Except for the turbine jet engine, the rotary engine has not, to date, been widely used in practice because it has serious design deficiencies and has heretofore been unable to meet requirements for simple, reliable and highly efficient work. The Wankel engine, for example, is a heavy consumer of oil and emits many pollutants because combustion is far from complete. The turbine jet engine's applications have been limited mostly to the aircraft industry because it demands special working conditions.

Prior vane rotary engine designs suffer from deteriorating gas-tightness between the rotor and the walls of the stators, lack of provision for effective air scavenging in the combustion space, unreliable fuel intake, excessive fuel consumption, high cost of manufacture due to complicated designs or inadequate lubrication of vane edges, reducing potential power through friction of the vanes on the casing or stator.

Prior vane rotary engine designs suffer from the same problems described above, mainly due to the difficulties of providing adequate support for the sliding vanes and maintaining an effective seal between the sliding vanes and the stationary and rotary members. Moreover, during operations at high rotation speeds, very high centrifugal forces can produce a great amount of stress between the vane and the housing, which can cause wear to the sealing member and the housing wall and can eventually lead to engine failure.

Engine starting and operations at low rotation speeds also demonstrate other disadvantages of these prior designs. At low rotation speeds, the centrifugal forces are not high enough to push the vanes from the slots to the housing. Low temperatures and viscous lubricants cam impede the vanes even if they are spring-loaded. The end result is that the vanes can become stuck within the slots, necessitating disassembly for repair.

Thus, there is a definite need for serious improvements with respect to these features as well as for general simplification in design and operation method.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for a new rotary vane-type engine having an improved work cycle.

It is another aspect of the disclosed embodiments to provide for a new rotary-vane mechanism (RVM) that substantially overcomes the disadvantages and deficiencies of predecessor engines, and to provide a rotary vane engine with a minimum number of parts, which is simpler in construction, light-weight and compact as well as being easy and reliable to operate and inexpensive to mass produce as compared to previous engines.

It is also an aspect of the disclosed embodiments to improve the combustion process for an engine and allow the engine to operate of using a variety of fuel types.

It is a further aspect of the disclosed embodiments to provide a rotary vane engine having a reliable engine start, and which can operate at very low rotation speeds (e.g., as low as one revolution per second or lower) as well as very high rotation speeds (e.g., up to 100 revolutions per second) without the problems associated with previous engines.

It is yet another aspect of the disclosed embodiments to implement a universal engine, which can operate with compressed fluid (e.g., compressed air, steam or any other appropriate compressed gas or liquid) and without the necessity of changing any parts other than simple valve switching.

The aforementioned aspects and other objectives and advantages can now be achieved as described herein.

In an embodiment, a rotary-vane mechanism can include: a rotor and a casing, wherein the rotor comprises a drive shaft and at least one vane; the casing having a quasi-cylindrical tubular shell or a quasi-spherical shell and support walls that support the drive shaft and wherein the rotor is mounted within the casing; the drive shaft extending outward from the casing, wherein the drive shaft touches the inner surface of the casing in at least one contact location, wherein the at least one contact location is provided by a sealing plate; the casing including intake ports, exhaust ports, ports for an ignition mechanism, wherein the intake ports are provided with one-way valves; the drive shaft comprising at least one guide slot which penetrates through the drive shaft wherein the at least one vane is located inside the at least one guide slot, wherein edges of the at least one vane constantly touches the inner surface of the casing during a rotor rotation of the rotor; the at least one vane having a rectangular shape or a discoid shape, wherein at least one sealing plate or at least one sealing ring is located along an edge of the at least one vane; and the rotor and the casing forming isolated spaces inside the rotary-vane mechanism and during the rotor rotation provides three work strokes for an engine, and two strokes for a compressor.

In an embodiment of the rotary-vane mechanism, the ignition mechanism can be, for example, a spark plug or a glow plug.

In an embodiment of the rotary-vane mechanism, the three work strokes can comprise: intake, power, and exhaust.

In an embodiment of the rotary-vane mechanism, the two strokes can comprise: intake and compression.

In an embodiment of the rotary-vane mechanism, the drive shaft can be located between an intake port and an exhaust port, and the rotor and the casing can form three isolated changing volume spaces within the rotary-vane mechanism.

In an embodiment of the rotary-vane mechanism, a casing inner surface contour can be formed by the edge of the at least one vane when the at least one vane is rotating around a center of the drive shaft and depends from a shape of the at least one vane, and a half of the casing inner surface contour can be adjacent to the at least one contact location and can be determined arbitrarily, and furthermore, a second half of the casing inner surface contour can be determined in accordance with a position of opposite edge of the at least one vane.

In an embodiment of the rotary-vane mechanism, the ignition mechanism can be located between 60 and 180 degrees after a center of the at least one contact location in a line of the rotor rotation.

In an embodiment of the rotary-vane mechanism, the casing can include one intake port, which can be located between 5 and 45 degrees after the at least one contact location in a line of the rotor rotation.

In an embodiment of the rotary-vane mechanism, the casing can include one exhaust port, which can be located between 100 and 5 degrees before the at least one contact location in a line of the rotor rotation.

In an embodiment of the rotary-vane mechanism, the casing can comprise two intake ports among the intake ports, two exhaust ports among the intake ports, and two ports for the ignition mechanism; the drive shaft can comprise two mutually perpendicular guide slots; the rotor can comprise four connected vanes located within the two mutually perpendicular guide slots; the drive shaft can be located in a center of the casing between the intake ports and the exhaust ports and touches the inner surface of the casing at two opposing contact locations; and the rotor and the casing can form four isolated spaces within the rotary-vane mechanism.

In an embodiment of the rotary-vane mechanism, the casing can include two ports for the ignition mechanism, which can be located between 45 and 90 degrees after the at least one contact location in a line of the rotor rotation.

In an embodiment of the rotary-vane mechanism, the casing can include two intake ports among the intake ports, which can be located between 5 and 30 degrees after the at least one contact location in a line of the rotor rotation.

In an embodiment of the rotary-vane mechanism, the casing can include two exhaust ports, which can be located between 30 and 5 degrees before the at least one contact location in a line of the rotor rotation.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates an exploded view of a rotary-vane mechanism that can be adapted for us with an engine, in accordance with an embodiment;

FIG. 2 illustrates a method of creating an inner surface contour a casing of a rotary-vane mechanism in accordance with an embodiment;

FIG. 3 illustrates a cross-sectional view of a rotary-vane mechanism, in accordance with an embodiment;

FIG. 4 illustrates a rotary-vane mechanism with a three-stroke engine operation at a cross-section of a rotary-vane mechanism casing, in accordance with an embodiment;

FIG. 5 illustrates a pressure-volume diagram of four-stroke and three-stroke engines;

FIG. 6 illustrates a rotary-vane mechanism with a quasi-spherical casing for a three-stroke engine, in accordance with an embodiment;

FIG. 7 illustrates a rotary-vane mechanism with a quasi-spherical casing (outer view in assembly) for a three-stroke engine in accordance with an embodiment;

FIG. 8 illustrates a rotary-vane mechanism with a casing having combined quasi-cylindrical and rounded rectangle shapes for a three-stroke engine, in accordance with an embodiment;

FIG. 9 illustrates a rotary-vane mechanism with combined quasi-cylindrical and rounded rectangle shapes for a three-stroke engine operation at a cross-section of the casing, in accordance with an embodiment;

FIG. 10 illustrates a cross sectional view of a rotary-vane mechanism in a three-stroke engine with four vanes, which can be connected, in accordance with an embodiment;

FIG. 11 illustrates an outer rotor view including a drive shaft and vanes, in accordance with an embodiment;

FIG. 12 illustrates a diagram depicting the operations of a rotary-vane mechanism at a cross-section in a three-stroke engine with four vanes, which can be connected in couples, in accordance with an embodiment;

FIG. 13 illustrates an exploded view of a rotary-vane mechanism that can include four vanes for three-stroke engine, in accordance with an embodiment;

FIG. 14 illustrates an image depicting an outer view of a real three stroke engine with a rotary-vane mechanism having one vane in an assembly, in accordance with an embodiment; and

FIG. 15 illustrates an image depicting an outer view of a three-stroke engine with a rotary-vane mechanism having one vane in a non-assembled condition, in accordance with an embodiment.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an embodiment” or “in an example embodiment” and variations thereof as utilized herein may not necessarily refer to the same embodiment, and the phrase “in another embodiment” or “in an alternative embodiment” and variations thereof as utilized herein may or may not necessarily refer to a different embodiment. It is intended, for example, that claimed subject matter may include combinations of example embodiments in whole or in part. The phrase “in an embodiment” may refer to the same embodiment or may refer to a different embodiment or an alternative embodiment.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

As will be discussed in greater detail herein, the disclosed embodiments relate to a new rotary-vane mechanism that can substantially overcome the disadvantages and deficiencies of predecessor engines including the implementation of a rotary vane engine with a minimum number of parts, which is simpler in construction than prior devices, and which is light-weight and compact as well as being easy and reliable to operate and much more inexpensive to mass produce that conventional mechanisms.

A preferred embodiment can be implemented as a rotary-vane mechanism that comprise a rotor and a casing, wherein the rotor can include a drive shaft and one or more vanes. The casing can include a quasi-cylindrical tubular shell or a quasi-spherical shell, and can provide walls that support the drive shaft. The rotor can be mounted within the casing. The drive shaft can extend outward from the casing, wherein the drive shaft touches the inner surface of the casing in one or more contact locations, with the contact location(s) provided by a sealing plate. The casing can include intake ports, exhaust ports, ports for an ignition mechanism, wherein the intake ports are provided with one-way valves. The drive shaft can include one or more guide slots, which can penetrate through the drive shaft wherein the vane(s) is located inside the guide slot(s), and edges of the vane(s) can constantly touch the inner surface of the casing during a rotor rotation of the rotor. Each vane can possess a rectangular shape or a discoid shape, and the sealing plate or a sealing ring can be located along an edge of the vane(s). The rotor and the casing can form isolated spaces inside the rotary-vane mechanism and during the rotor rotation can provide three work strokes for an engine, and two strokes for a compressor.

The embodiments can further provide for a combustion process that allows an engine to use a variety of different types of fuels. In addition, the embodiments can provide a rotary vane engine with a reliable engine start that can operate at very low rotation speeds (e.g., as low as one revolution per second or lower) as well as very high rotation speeds (e.g., up to 100 revolutions per second) without the problems discussed above.

The embodiments can further facilitate the creation of a universal engine that can be operated on compressed fluid (e.g., compressed air, steam or any other appropriate compressed gas or liquid) without the necessity of changing any parts other than simple valve switching.

The disclosed rotary-vane mechanism can be characterized by increased efficiency, low centrifugal vane forces impact, easy and reliable operation at a very low rotation speed, few moving parts and low cost, while offering a low weight and a small size with high efficiency. Such improvements can result from the specific character of the operation method, low friction losses, no heavy flywheel, improved vane support, and an improved rotor, vanes and stator design.

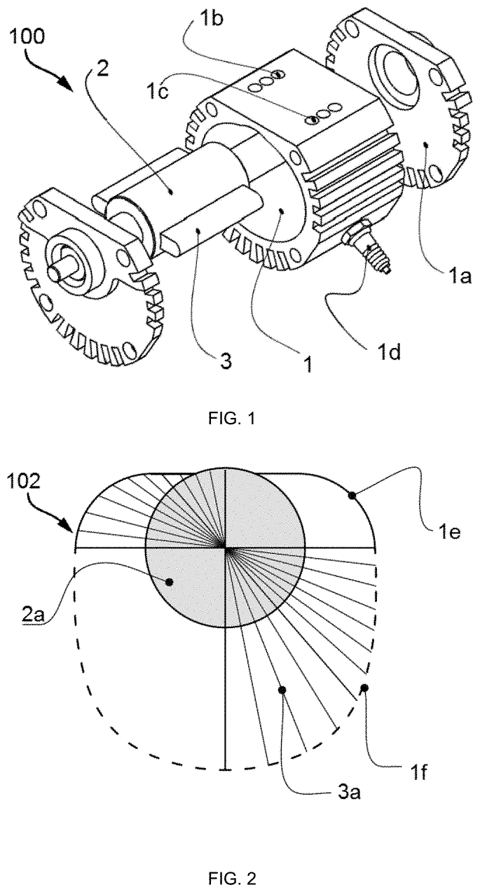

FIG. 1 illustrates an exploded view of rotary-vane mechanism for a three-stroke engine 100, in accordance with an embodiment. As shown in FIG. 1, the engine 100 can include a shell 1, support walls 1a, and exhaust port 1b, intake port 1c, spark plug 1d, a drive shaft 2, and a vane 3. As will be described in more detail herein, the shell 1 and two support walls 1a together form a casing, it can be configured as a quasi-cylindrical tubular shell among other potential shapes. As shown in FIG. 1, the rotor includes a drive shaft 2 and a vane 3. The rotor shown in FIG. 1 contains a drive shaft 2 and a vane 3 and can be implemented with the engine casing 100 shown in FIG. 1.

FIG. 2 illustrates a method 102 of creating inner surface contour of a rotary-vane mechanism casing, in accordance with an embodiment. The casing inner surface contour can be formed by the edges of the vane 3a when the vane 3a is rotating around the shaft 2a center and depends from the vane shape, at half of the contour 1e (i.e., as indicated by firm line in FIG. 2), which is adjacent to the contact place determined arbitrarily and the second half of the contour 1f (i.e., see dotted line in FIG. 2) determined in accordance with the position of the opposite edge of the vane. Note that the term “casing” as utilized herein can refer to an RVM casing. A RVM casing form vane moving disposition, support drive shaft and can be used to protect and house an engine components. Furthermore, as discussed previously, the acronym RVM refers to ‘rotary-vane mechanism’.

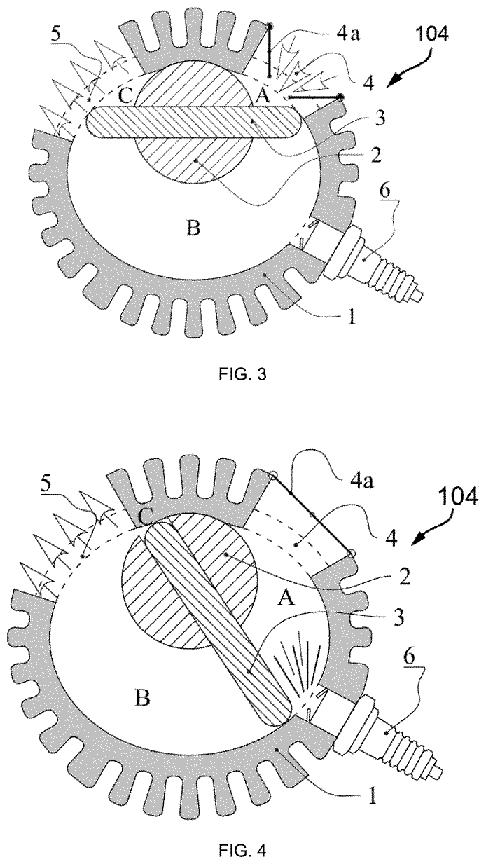

FIG. 3 illustrates a cross-sectional view of a rotary-vane mechanism 104 for the three-stroke engine casing 100 of FIG. 1, in accordance with an embodiment. Note that as utilized herein, identical or similar parts or elements are indicated by identical reference numerals. Thus, some of the features shown in FIG. 1 and FIG. 2 are also depicted in FIG. 3, such as the shell 1, the drive shaft 2 and the vane 3. The rotary-vane mechanism 104 can further include an inlet port 4 with a one-way valve 4a. The rotary-vane mechanism 104 can also include an outlet port 5, and a spark plug 6. A chamber A is shown in FIG. 3 with the one-way valve 4a in an open position and with the start of the intake stroke. A chamber B is depicted with the end of the power stroke and the start of the exhaust stroke. A chamber C is shown with respect to the end of the exhaust stroke.

FIG. 4 illustrates a cross-sectional view of the rotary-vane mechanism 104 depicted in FIG. 4 in a three-stroke engine operation of the three-stroke engine 100 of FIG. 1, in accordance with an embodiment. The operations shown in FIG. 4 can be summarized as follows: a chamber A is depicted with the start of the power stroke and with closed one-way valve 4a; a chamber C is shown with the end of the exhaust stroke; a chamber B is shown with the prolongation of the exhaust stroke.

For a three-stroke engine, the rotary-vane mechanism 104 shown and described herein with respect to FIGS. 1-4 can include an engine 100 that can be formed by a quasi-cylindrical tubular shell and the two flat walls 1a, which can support the shaft. The vane 3 can be configured with a rectangular shape. The shaft 2 is shifted from the center of the shell 1 so that the shaft 2 is touching to the shell 1 between the intake port 4 and the exhaust port 5. The shaft 2, the vane 3, the support walls 1a, and the shell 1 do form three separate spaces (A-B-C) inside the rotary-vane mechanism 104. The spark plug 6 can be located after the intake port 4 in the direction of rotor rotation. The intake port 4 can be fitted with a one-way valve. The volumes of the A, B and C chambers can change as the rotary-vane mechanism 104 creates three sequential work strokes through rotor rotation: intake, combustion (power) and exhaust.

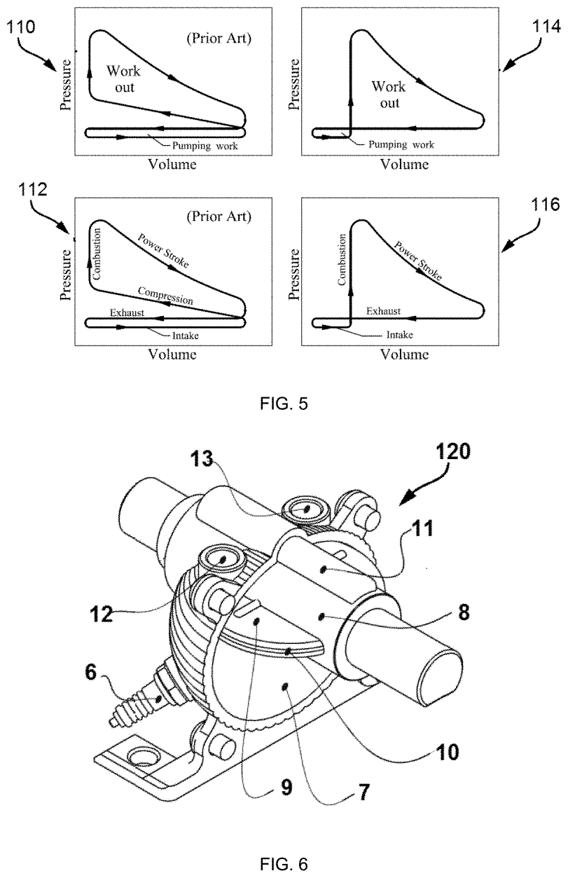

FIG. 5 illustrates a prior art pressure-volume diagram 110 and a prior art pressure-volume diagram 112 of a four-stroke engine, and a pressure-volume diagram 114 and a pressure-volume diagram 116 of a three-stroke engine, in accordance with the disclosed embodiments. FIG. 5 compares the pressure-volume of four-stroke engines (see diagrams at the left of FIG. 5, representing a prior design implementing the Otto cycle) and three-stroke engines (see diagrams at the right of FIG. 5).

FIG. 6 illustrates a pictorial view of a rotary-vane mechanism for three-stroke engine 120 configured in a half assembly with a quasi-spherical casing 7 (i.e., an engine casing), in accordance with an embodiment. The three-stroke engine 120 shown in FIG. 6 includes the quasi-spherical casing 7, a shaft 8, a vane 9, a compression ring 10, a sealing plate 11, an intake port 12, and an exhaust port 13.

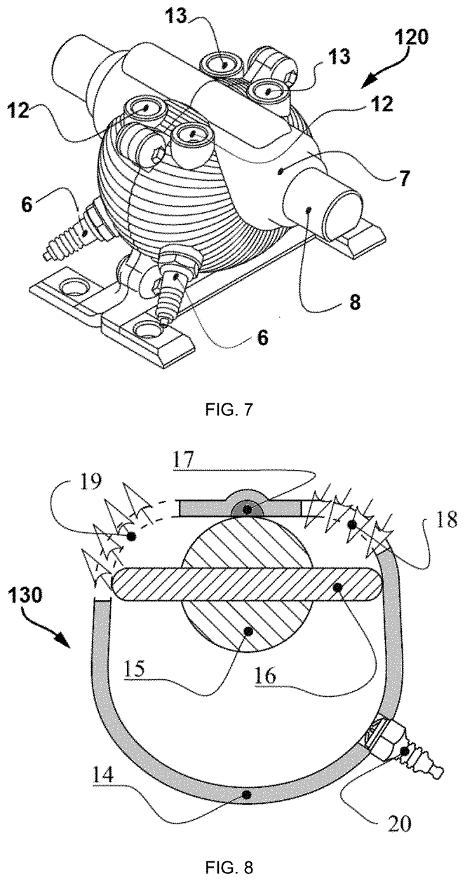

FIG. 7 illustrates a pictorial view of the three-stroke engine 120 depicted in FIG. 6 with an outer view of the quasi-spherical casing 7 in fully assembly, in accordance with an embodiment.

FIG. 6 and FIG. 7 illustrate another type of rotary-vane mechanism, which can be adapted for use and/or incorporated with a three-stroke engine. FIG. 6 and FIG. 7 depict a casing formed by two quasi-hemispherical support walls 7. The vane 9 can be configured with a disk shape with at least one compression rink 11 on the perimeter of the disk. The shaft 8 can be shifted from the center of the support walls 7 to the top of the quasi-spherical casing. The shaft 8 can be located between the intake port 12 and the exhaust port 13. The shaft 8, the vane 9 and the casing 7 can facilitate the creation of three separate spaces within the rotary-vane mechanism to create the three work strokes described above. One or more spark plugs can be located after the intake port 12, in the direction of rotor rotation. Again, the intake port can be fitted with a one-way valve.

FIG. 8 illustrates a rotary-vane mechanism for three-stroke engine 130 with a casing 14 configured with combined quasi-cylindrical and rounded rectangle shapes, in accordance with an embodiment. The three-stroke engine 130 shown in FIG. 8 includes the casing 14, a shaft 15, a vane, 16, a sealing plate 17, an intake port 18, an exhaust port 19, and at least one spark plug 20. The three-stroke engine 130 can function according to the following operations: chamber A—intake stroke; chamber B—the end of power stroke and start exhaust stroke; and chamber C—exhaust stroke.

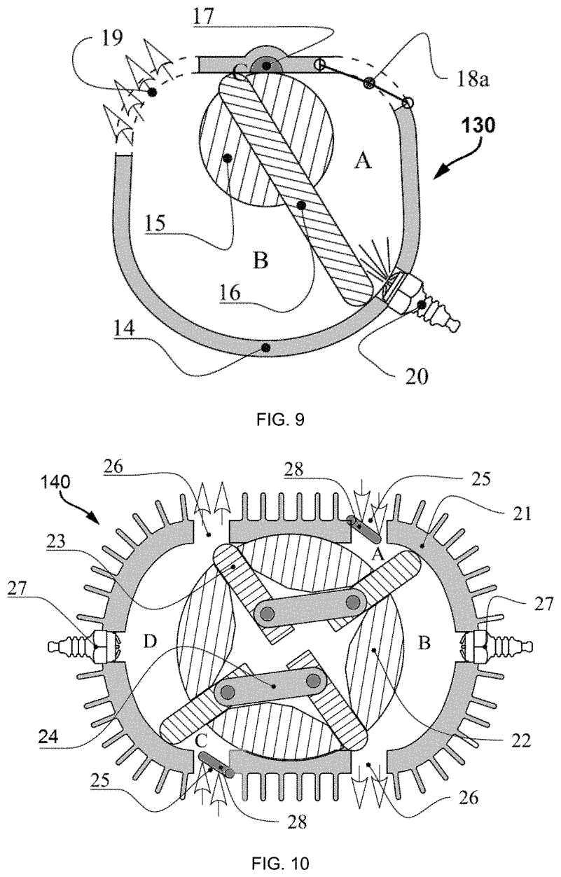

FIG. 9 illustrates a diagram depicting operations of a rotary-vane mechanism at a cross sectional view of the casing 14 of the three-stroke engine 130 (combined quasi-cylindrical and rounded rectangle shapes) shown in FIG. 8, in accordance with an embodiment. The following operations are shown in FIG. 9: chamber A—the end of intake stroke and start of power stroke; Chamber B—exhaust stroke; and Chamber C—the end of exhaust stroke.

FIG. 8 and FIG. 9 thus illustrate a third type of rotary-vane mechanism in which the casing 14 can be formed by a combination of quasi-cylindrical and rounded rectangular shapes. The intake port 18 and the exhaust port 19 can be located in the rectangular area, while the cylindrical area can house the spark plugs. A seal plate 17 can be located between the intake port 18 and the exhaust port 19. One or more spark plugs 20 can be located after the intake port 18 in the direction of rotor rotation, and here again; the intake port can be fitted with a one-way valve 18a. The vane 16 can possess a rectangular shape. The shaft 15, the vane 16 and the casing 14 can create three separate spaces, A-B-C, within the rotary-vane mechanism with volumes that can change as the rotary-vane mechanism can create three sequential work strokes at rotor rotation: intake, combustion (power), exhaust.

The three types of rotary-vane mechanism (FIG. 1, FIG. 7, FIG. 8) can function in the same manner (e.g., see FIG. 5). During the intake stroke (e.g., see FIG. 3, FIG. 4, FIG. 8, FIG. 9), an air-fuel mix (or any oxidizing gas-fuel mix) or else just air (or any oxidizing gas), depending on how the engine is intended to be powered and/or is introduced into a revolving chamber A. The intake stroke can proceed through about 90-180 degrees of shaft rotation, ending when the vane reaches the spark plug, whereupon the air-fuel mixture ignites, beginning the power stroke.

During the power stroke (e.g., see FIG. 3, FIG. 4, FIG. 8, FIG. 9), the air-fuel mix combusts, which can produce heat and pressure that, can force the rotor into rotation. The power stroke can proceed through about 90-180 degrees of shaft rotation, ending when the vane reaches the exhaust port. During the exhaust stroke the spinning rotor forces burn gases out of the engine. This can occur during approximately 90-180 degrees of shaft rotation.

The disclosed rotary-vane mechanism can be used for engines operating from any compressed fluid (e.g., compressed air, high pressure steam, high pressure water or oil) without fuel combustion. When operated this way, the intake port may not require a one-way valve, and no spark plugs may be needed.

The rotary-vane mechanism for a three-stroke cycle can offer a number of advantages (e.g., see FIG. 5). For example, the three-stroke engine is easy to switch from operation with a fuel-air mixture to an operation with compressed fluids. The engine may note need a heavy fly wheel because it has no TDC and BDC. In addition, no energy losses are present during the compression stroke. In addition, the engine can operate at comparatively low pressures and temperatures and with low noise and vibration levels, so it places few demands on its working environment. Furthermore, different types of fuels can be used without extensive modifications. Additionally, the engine may not require a spark distributor. The engine can also operate at a very low rotation speed, and the engine start is easy and reliable.

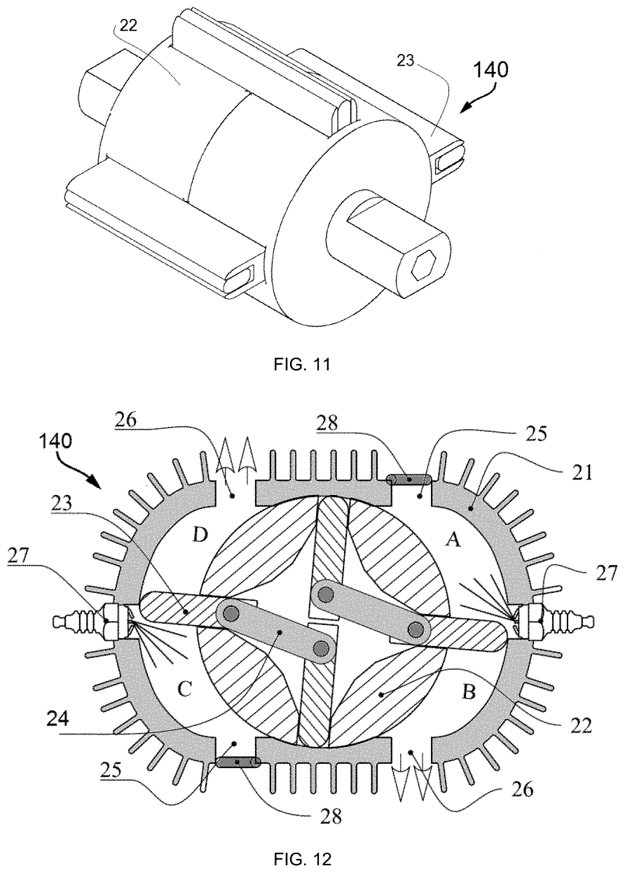

FIG. 10 illustrates a cross section of the rotary-vane mechanism 140 in a three-stroke engine with four vanes, which are connected in couples, in accordance with an embodiment. As shown in FIG. 10, the rotary-vane mechanism 140 includes a casing 21, a drive shaft 22, a vane 23, connecting plates 24, two intake ports 25, two exhaust ports 26, and two ignition ports (spark plug 27). FIG. 10 illustrates also operations of the RVM 140 including the following: chamber A—start of intake stroke; chamber B—start of exhaust stroke; chamber C—start of intake stroke; and chamber D—start of exhaust stroke.

FIG. 11 illustrates an outer rotor view of the rotary-vane mechanism 140 shown in FIG. 10 including a drive shaft 22 and four vanes 23, in accordance with an embodiment.

FIG. 12 illustrates the rotary-vane mechanism operation diagram at a cross-section in a three-stroke engine with four vanes, which are connected in couples, in accordance with an embodiment. FIG. 12 illustrates operations of the rotary-vane mechanism 140 including the following: chamber A—start of power stroke; chamber B—the prolongation of exhaust stroke; chamber C—start of power stroke; and chamber D—the prolongation of exhaust stroke.

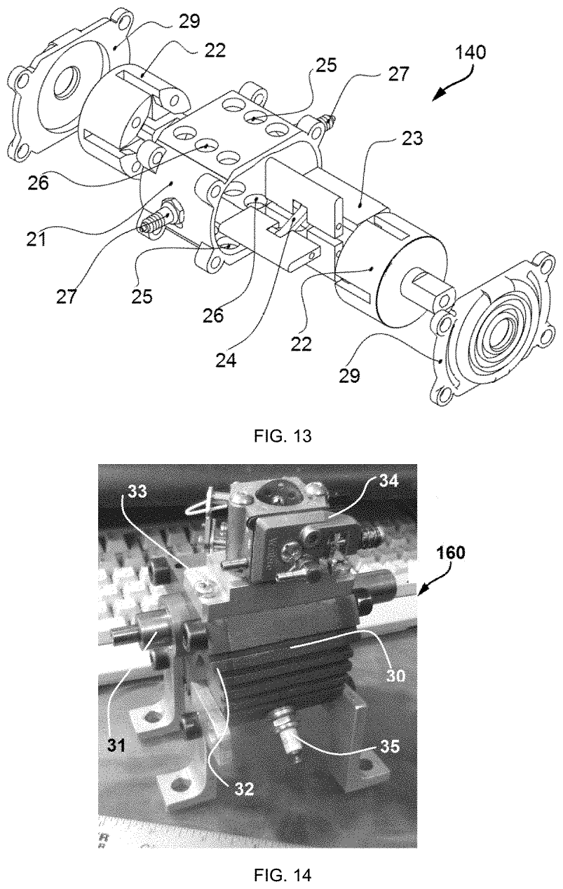

FIG. 13 illustrates an exploded view of the rotary-vane mechanism for three-stroke engine having four vanes in accordance with an embodiment. As shown in FIG. 10, FIGS. 12, and 13, the rotary-vane mechanism 140 includes a casing 21, a drive shaft 22, four vanes 23, two or more connecting plates 24, two intake ports 25, two exhaust ports 26, at least two spark plugs 27, and two support walls 29.

FIG. 14 illustrates an image depicting an outer view of a real workable assembled three-stroke engine 160 with the rotary-vane mechanism 104 having one vane in an assembly, in accordance with an embodiment. The engine 160 shown in FIG. 14 includes a shell 30, a drive shaft 31, two support walls 32, a one-way valve 33, a carburetor 34, and a spark plug 35.

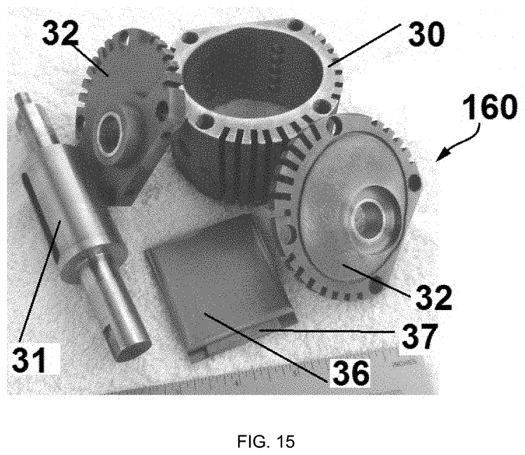

FIG. 15 illustrates an image depicting an outer view of the three-stroke engine 160 with rotary-vane mechanism having one vane in a non-assembled condition, in accordance with an embodiment. FIG. 15 depicts a shell 30, two support walls 32, a drive shaft 31, a vane 36, and four sealing plates such as a sealing plate 37.

Below are parameters of the workable three-stroke engine (FIG. 1 and FIG. 14)

### Overall Dimensions:

### Diameter—80 MM

Length (without shaft)—80 MM
Volume—0.4 liter
Weight (without infrastructure, totally made of steel)—1.5 kg.

### Operational Factors:

Type—three stroke
Combustion chamber volume—24 cc
Maximum work chamber volume in the end of work stroke—90 cc
2-power stroke per one rev of drive shaft
Calculated power at 3000 rev/min 4.5 hp (3.5 kW)
Fuel—propane, gasoline, alcohol, hydrogen
Rotation speed range—from 60 to 3000 rev/min
Engine start—by hand
Ignition type—spark plug

A prototype of the engine (FIG. 14) has been fire-tested for a total of 500 hours as of the time of submission of this patent application. Tests with various fuels were successful, as were tests with compressed air. The objectives stated above were attained.

Numerous fire testing of the prototype has demonstrated optimum parameters of a vane rotary-vane mechanism design wherein the spark plug port should be located between 60 and 180 degrees after center of the rotor-casing contact place (in the line of rotor rotation), and the intake port should be located between 5 and 45 degrees after center of the contact place, and additionally, the exhaust port should be located between 100 and 5 degrees before center of the contact place.

Optimum location of spark plugs, intake ports, and exhaust ports for three stroke four-vane engine have been found by calculations: spark plug ports should be located between 45 and 90 degrees after centers of the contact places; intake ports should be located between 5 and 30 degrees after center of the contact places; exhaust ports should be located between 30 and 5 degrees before the center of contact place.

Based on the foregoing, it can be appreciated that preferred and alternative embodiments are disclosed herein. For example, in one embodiment, a rotary-vane mechanism for engines and compressors can be implemented, which can include a mechanism for intake, exhaust, cooling, lubrication, gas mixture and ignition and in which a rotor can be mounted inside a casing having a rounded inner shape and a drive shaft with at least one radial guide slot and at least one vane inside the slot, so that the guide slot (or slots) can penetrate completely through the shaft and the edges of the vane (or vanes) protruding from the shaft slide along the inner surface of the casing during rotor rotation.

In some embodiments, the casing can be formed by a quasi-cylindrical tubular shell and two flat walls that can support the shaft, which can be attached to the inner casing surface off center between the intake and exhaust ports and which can include a rectangular vane with sealing plates along its edge, so that the shaft, the vane, the support walls and the casing can form three distinct spaces within the rotary-vane mechanism. In addition, an ignition apparatus (e.g., one or more spark plugs) can be located after (e.g., in the direction of rotor rotation) the intake mechanism, so that as the rotor rotates, the changing space volumes inside the casing can create three sequential work strokes: intake, combustion (e.g., power), and exhaust.

In some embodiments, the inner space of the casing can be quasi-spherical, and formed by two quasi-hemispherical support walls, with the vane having a disk shape with at least one compression rink on its perimeter.

In some embodiment, the casing's inner shape can be a combination of quasi-cylindrical and rounded rectangular shapes, so that the intake and exhaust mechanisms can be located within the rectangular area, and can be separated from each other by a seal plate, and such that the ignition can be located in the cylindrical area.

In other embodiments, the casing can be formed from a rounded rectangular tube and two walls that can support the shaft, and which can be centered inside the casing and can support four vanes that can slide inside two slots (e.g., two vanes per slot) in opposite directions. Furthermore, an ignition mechanism (e.g., one or more spark plugs) can be located after the ignition mechanism (e.g., in the direction of rotor rotation) in a compression chamber with an intake and an exhaust located symmetrically with respect to the shaft and opposite to the ignition, so that the shaft, the vanes, the support walls and the casing can form four separate spaces within the rotary-vane mechanism that can change shape and volume as the rotor rotates, and which can create four sequential work strokes: intake, compression, combustion (e.g., power), and exhaust.

In some embodiments the opposite vanes can be connected in couples by compression springs. In other embodiments, hinged connected plates can connect adjoining vanes. Furthermore, in some embodiments, four respective hinged connecting plates can connect the four vanes.

The disclosed embodiments can apply to the design of a rotary mechanism (RM) for engines and compressors with high productivity, low noise and vibration level and low friction losses. These engines and compressors are very light and small, with few moving parts. The disclosed rotary-vane mechanism can include cylindrical shaft having one or two radial guide slots. One to four plates and vanes can be implemented inside a guide slot can be mounted inside a rounded casing and two support walls. The guide slots can penetrate the rotor shaft. The casing can include a noncircular cylindrical shape, an intake mechanism, an exhaust mechanism and an ignition mechanism. The vane faces can be in continuous contact with the inner surface of the casing, the drive shaft, and walls during shaft rotation.

As the shaft rotates, the space volumes confined by the drive shaft, the vanes, the support walls and the casing change, so that the rotor's rotation can create three or four sequential work strokes, depending on the number of vanes in the engine or the compressor's rotary-vane mechanism (i.e., intake, combustion-power stroke, exhaust or intake, compression-power stroke, combustion, and exhaust).

In another embodiment, a rotary-vane mechanism can include: a rotor and a casing, wherein the rotor comprises a drive shaft and at least one vane; the casing having a quasi-cylindrical tubular shell or a quasi-spherical shell and support walls that support the drive shaft and wherein the rotor is mounted within the casing; the drive shaft extending outward from the casing, wherein the drive shaft touches the inner surface of the casing in at least one contact location, wherein the at least one contact location is provided by a sealing plate; the casing including intake ports, exhaust ports, ports for an ignition mechanism, wherein the intake ports are provided with one-way valves; the drive shaft comprising at least one guide slot which penetrates through the drive shaft wherein the at least one vane is located inside the at least one guide slot, wherein edges of the at least one vane constantly touches the inner surface of the casing during a rotor rotation of the rotor; the at least one vane having a rectangular shape or a discoid shape, wherein at least one sealing plate or at least one sealing ring is located along an edge of the at least one vane; and the rotor and the casing forming isolated spaces inside the rotary-vane mechanism and during the rotor rotation provides three work strokes for an engine, and two strokes for a compressor.

In an embodiment of the rotary-vane mechanism, the ignition mechanism can be, for example, a spark plug or a glow plug.

In an embodiment of the rotary-vane mechanism, the three work strokes can comprise: intake, power, and exhaust.

In an embodiment of the rotary-vane mechanism, the two strokes can comprise: intake and compression.

In an embodiment of the rotary-vane mechanism, the drive shaft can be located between an intake port and an exhaust port, and the rotor and the casing can form three isolated changing volume spaces within the rotary-vane mechanism.

In an embodiment of the rotary-vane mechanism, a casing inner surface contour can be formed by the edge of the at least one vane when the at least one vane is rotating around a center of the drive shaft and depends from a shape of the at least one vane, and a half of the casing inner surface contour can be adjacent to the at least one contact location and can be determined arbitrarily, and furthermore, a second half of the casing inner surface contour can be determined in accordance with a position of opposite edge of the at least one vane.

In an embodiment of the rotary-vane mechanism, the ignition mechanism can be located between 60 and 180 degrees after a center of the at least one contact location in a line of the rotor rotation.

In an embodiment of the rotary-vane mechanism, the casing can include one intake port, which can be located between 5 and 45 degrees after the at least one contact location in a line of the rotor rotation.

In an embodiment of the rotary-vane mechanism, the casing can include one exhaust port, which can be located between 100 and 5 degrees before the at least one contact location in a line of the rotor rotation.

In an embodiment of the rotary-vane mechanism, the casing can comprise two intake ports among the intake ports, two exhaust ports among the intake ports, and two ports for the ignition mechanism; the drive shaft can comprise two mutually perpendicular guide slots; the rotor can comprise four connected vanes located within the two mutually perpendicular guide slots; the drive shaft can be located in a center of the casing between the intake ports and the exhaust ports and touches the inner surface of the casing at two opposing contact locations; and the rotor and the casing can form four isolated spaces within the rotary-vane mechanism.

In an embodiment of the rotary-vane mechanism, the casing can include two ports for the ignition mechanism, which can be located between 45 and 90 degrees after the at least one contact location in a line of the rotor rotation.

In an embodiment of the rotary-vane mechanism, the casing can include two intake ports among the intake ports, which can be located between 5 and 30 degrees after the at least one contact location in a line of the rotor rotation.

In an embodiment of the rotary-vane mechanism, the casing can include two exhaust ports, which can be located between 30 and 5 degrees before the at least one contact location in a line of the rotor rotation.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

1. A rotary-vane mechanism, comprising:
a rotor and a casing, wherein the rotor comprises a drive shaft and at least one vane;
the casing having a quasi-cylindrical tubular shell or a quasi-spherical shell and support walls that support the drive shaft and wherein the rotor is mounted within the casing;
the drive shaft extending outward from the casing, wherein the drive shaft touches the inner surface of the casing in at least one contact location, wherein the at least one contact location is provided by a sealing plate;
the casing including intake ports, exhaust ports, ports for an ignition mechanism, wherein the intake ports are provided with one-way valves;
the drive shaft comprising at least one guide slot which penetrates through the drive shaft wherein the at least one vane is located inside the at least one guide slot, wherein edges of the at least one vane constantly touches the inner surface of the casing during a rotor rotation of the rotor;
the at least one vane having a rectangular shape or a discoid shape, wherein at least one sealing plate or at least one sealing ring is located along an edge of the at least one vane; and
the rotor and the casing forming isolated spaces inside the rotary-vane mechanism and during the rotor rotation provides three work strokes for an engine, and two strokes for a compressor.

2. The rotary-vane mechanism of claim 1 wherein the ignition mechanism comprises at least one of: a spark plug or a glow plug.

3. The rotary-vane mechanism of claim 1 wherein the three work strokes comprises intake, power, and exhaust.

4. The rotary-vane mechanism of claim 1 wherein the two strokes comprises intake and compression.

5. The rotary-vane mechanism of claim 1 wherein:
the drive shaft is located between an intake port and an exhaust port; and
the rotor and the casing forming three isolated changing volume spaces within the rotary-vane mechanism.

6. The rotary-vane mechanism of claim 1 wherein:
a casing inner surface contour is formed by the edge of the at least one vane when the at least one vane is rotating around a center of the drive shaft and depends from a shape of the at least one vane;
a half of the casing inner surface contour is adjacent to the at least one contact location and is determined arbitrarily and a second half of the casing inner surface contour is determined in accordance with a position of opposite edge of the at least one vane.

7. The rotary-vane mechanism of claim 1 wherein the ignition mechanism is located between 60 and 180 degrees after a center of the at least one contact location in a line of the rotor rotation.

8. The rotary-vane mechanism of claim 1 wherein the casing has one intake port which is located between 5 and 45 degrees after the at least one contact location in a line of the rotor rotation.

9. The rotary-vane mechanism of claim 1 wherein the casing has one exhaust port which is located between 100 and 5 degrees before the at least one contact location in a line of the rotor rotation.

10. The rotary-vane mechanism, of claim 1 wherein:
the casing comprises two intake ports among the intake ports, two exhaust ports among the intake ports, and two ports for the ignition mechanism;
the drive shaft comprises two mutually perpendicular guide slots;
the rotor comprises four connected vanes located within the two mutually perpendicular guide slots;
the drive shaft is located in a center of the casing between the intake ports and the exhaust ports and touches the inner surface of the casing at two opposing contact locations; and
the rotor and the casing forming four isolated spaces inside the rotary-vane mechanism.

11. The rotary-vane mechanism of claim 10 wherein the casing comprises two ports for the ignition mechanism which are located between 45 and 90 degrees after the at least one contact location in a line of the rotor rotation.

12. The rotary-vane mechanism of claim 10 wherein the casing comprises two intake ports among the exhaust ports, which are located between 5 and 30 degrees after the at least one contact location in a line of the rotor rotation.

13. The rotary-vane mechanism of claim 10 wherein the casing has two exhaust ports which is located between 30 and 5 degrees before the at least one contact location in a line of the rotor rotation.
